(19) United States
(12) Patent Application Publication
(10) Pub. No.: US 2025/0083921 A1
(43) Pub. Date: Mar. 13, 2025

(54) IMAGE FORMING APPARATUS

(71) Applicant: FUJIFILM Business Innovation Corp., Tokyo (JP)

(72) Inventors: Takayuki SUEHIRO, Kanagawa (JP); Teruyo Ryuzaki, Kanagawa (JP); Takayuki Kikuchi, Kanagawa (JP)

(73) Assignee: FUJIFILM Business Innovation Corp., Tokyo (JP)

(21) Appl. No.: 18/587,063

(22) Filed: Feb. 26, 2024

(30) Foreign Application Priority Data
Sep. 11, 2023 (JP) 2023-147135

(51) Int. Cl. B65H 29/24; B65H 5/22

(52) U.S. Cl. CPC B65H 29/245; B65H 5/228

(57) ABSTRACT

An image forming apparatus includes: an image forming section that forms an image to be formed on a recording medium; a sending out section that sends out a gas to be supplied to the image forming section; an accommodating section that is at least partially disposed below the sending out section and that accommodates the recording medium; and a receiving section that is disposed between a lower portion, which is a portion of the accommodating section positioned below the sending out section, and the sending out section, and receives a falling object from the sending out section.

### CROSS-REFERENCE TO RELATED APPLICATIONS

This application is based on and claims priority under 35 USC 119 from Japanese Patent Application No. 2023-147135 filed Sep. 11, 2023.

### BACKGROUND

### (i) Technical Field

The present invention relates to an image forming apparatus.

### (ii) Related Art

JP2015-132856A discloses a configuration in which air taken in from an intake port enters an air passage covered with a duct and reaches an internal space of an operation section housing, and air is introduced to the internal space of a body housing via a communication section.

JP2001-241744A discloses a rib duct in which a plurality of oblique ribs projecting outward are provided on a configuration surface of a tubular duct at intervals.

JP2019-101172A discloses a configuration in which a component facing portion facing a toner bottle is formed to have a cross-sectional area smaller than a cross-sectional area of a fan installation portion, and absorbs heat of air around the toner bottle via a wall portion of the component facing portion thereby preventing the toner bottle from becoming hot.

### SUMMARY

In an image forming apparatus, a gas may be supplied to an image forming section by sending out the gas from a sending out section that sends out the gas to the image forming section that forms an image.

In many cases, powder can be circulated through the sending out section, and depending on an aspect of disposition of the sending out section, toner or the like used for forming an image may fall downward through the sending out section. In a configuration in which a recording medium is positioned below the sending out section, the recording medium may be contaminated by a falling object from the sending out section.

Aspects of non-limiting embodiments of the present disclosure relate to an image forming apparatus that reduces adhesion of a falling object from a sending out section to a recording medium, as compared with a configuration in which a function of receiving the falling object from the sending out section for sending out a gas is not provided.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an image forming apparatus including: an image forming section that forms an image to be formed on a recording medium; a sending out section that sends out a gas to be supplied to the image forming section; an accommodating section that is at least partially disposed below the sending out section and that accommodates the recording medium; and a receiving section that is disposed between a lower portion, which is a portion of the accommodating section positioned below the sending out section, and the sending out section, and receives a falling object from the sending out section.

### BRIEF DESCRIPTION OF THE DRAWINGS

Exemplary embodiment(s) of the present invention will be described in detail based on the following figures, wherein:

FIG. 1 is a diagram showing an overall configuration of an image forming apparatus;

FIG. 2 is a diagram for describing a configuration of a control section;

FIG. 3 is a diagram of a case where a sending out section, an accommodating member, and the like provided in a gas supply apparatus are viewed from a direction indicated by an arrow III in FIG. 1;

FIG. 4 is a perspective diagram of a case where the accommodating member is viewed from obliquely below;

FIG. 5 is a perspective diagram of a case where the accommodating member and the sending out section are viewed from above;

FIG. 6 is a cross-sectional diagram of the accommodating member and the sending out section in VI-VI line of FIG. 5;

FIG. 7 is a diagram showing a case where the accommodating member and the sending out section are viewed from a direction indicated by an arrow VII in FIG. 5;

FIG. 8 is a diagram of a case where the accommodating member and the sending out section are viewed from a direction indicated by an arrow VIII in FIG. 7; and

FIGS. 9A and 9B are diagrams showing other disposition examples of the image forming apparatus.

### DETAILED DESCRIPTION

Hereinafter, an exemplary embodiment of the present disclosure will be described with reference to the accompanying drawings.

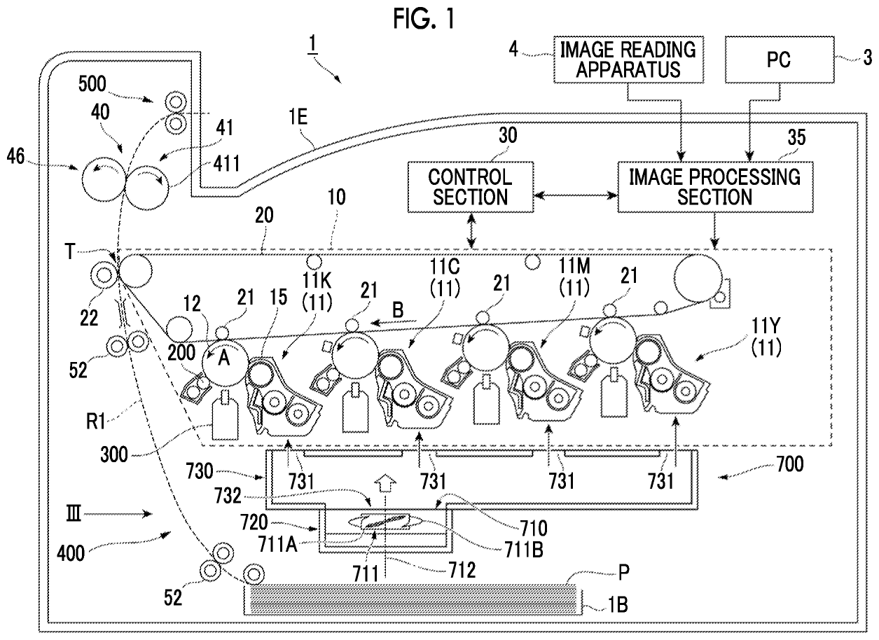

FIG. 1 is a diagram showing an overall configuration of an image forming apparatus 1. FIG. 1 shows a state of a case where the image forming apparatus 1 is viewed from a front side of the image forming apparatus 1.

The image forming apparatus 1 includes an image forming section 10.

The image forming section 10 forms an image to be formed on a paper P, which is an example of a recording medium, based on image data input to the image forming apparatus 1. In addition, the image forming apparatus 1 is provided with a paper transport apparatus 400 that transports the paper P.

In the present exemplary embodiment, the image formed by the image forming section 10 is transferred to the paper P transported by the paper transport apparatus 400.

The paper transport apparatus 400 transports the paper P accommodated in a paper accommodating section 1B as an example of an accommodating section via a secondary transfer section T and a fixing apparatus 40, and finally transports the paper P to a paper loading section 1E.

The paper transport apparatus 400 is provided with transport rolls 52 and discharge rolls 500. In the paper transport apparatus 400, the transport rolls 52 and the discharge rolls 500 are used to transport the paper P.

Further, the image forming apparatus 1 is provided with a control section 30 and an image processing section 35.

The control section 30 controls each functional section provided in the image forming apparatus 1. The image processing section 35 performs image processing on image data from a personal computer (PC) 3, an image reading apparatus 4, or the like.

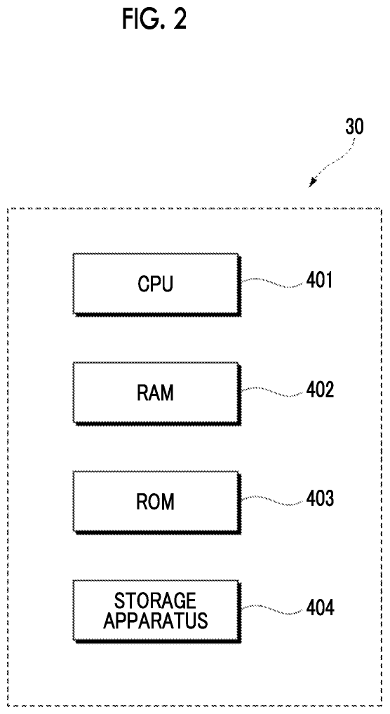

FIG. 2 is a diagram for describing a configuration of the control section 30.

As shown in FIG. 2, the control section 30 is provided with a storage apparatus 404 configured by a central processing unit (CPU) 401 as an example of a processor, a random access memory (RAM) 402, a read only memory (ROM) 403, a hard disk, and the like.

The ROM 403 and the storage apparatus 404 store a program executed by the CPU 401. The CPU 401 reads the program stored in the ROM 403 or the storage apparatus 404, and executes the program using the RAM 402 as a work area.

By executing the program stored in the ROM 403 or the storage apparatus 404 by the CPU 401, various functions of the image forming apparatus 1 are realized.

A program executed by the CPU 401 may be provided to the image forming apparatus 1 in a state of being stored in a computer readable recording medium such as a magnetic recording medium (magnetic tape, magnetic disk, or the like), an optical recording medium (optical disk, or the like), an optical magnetic recording medium, or a semiconductor memory. The program executed by the CPU 401 may be provided to the image forming apparatus 1 by using communication means such as the Internet.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The image forming apparatus 1 will be further described with reference to FIG. 1.

The image forming section 10 is provided with four image forming units 11Y, 11M, 11C, and 11K (hereinafter, also referred to as “image forming unit 11” simply and collectively) disposed in parallel at regular intervals.

The image forming units 11 have the same configuration except for toner that is stored in a developing apparatus 15. The image forming units 11 respectively form yellow (Y), magenta (M), cyan (C), and black (K) toner images (images).

Each of the image forming units 11 is provided with a photoreceptor drum 12, a charging apparatus 200 for charging the photoreceptor drum 12, and an exposure apparatus 300 for exposing the photoreceptor drum 12.

In the present exemplary embodiment, the photoreceptor drum 12 is charged by the charging apparatus 200. Next, the exposure apparatus 300 exposes the photoreceptor drum 12, and an electrostatic latent image is formed on the photoreceptor drum 12.

Each image forming unit 11 is further provided with a developing apparatus 15 that develops the electrostatic latent image formed on the photoreceptor drum 12. Development is performed by the developing apparatus 15, and a toner image is formed on the photoreceptor drum 12.

Further, the image forming section 10 is provided with an intermediate transfer belt 20 to which the toner image formed on the photoreceptor drum 12 is transferred and a primary transfer roll 21 to transfer the toner image formed on the photoreceptor drum 12 to the intermediate transfer belt 20.

Further, the image forming section 10 is provided with a secondary transfer roll 22 that transfers the toner image transferred on the intermediate transfer belt 20 to the paper P, and a fixing apparatus 40 that fixes the toner image transferred to the paper P to the paper P.

In the present exemplary embodiment, the toner image formed on the photoreceptor drum 12 is transferred to the intermediate transfer belt 20 and then transferred from the intermediate transfer belt 20 to the paper P. Then, the toner image is fixed to the paper P by the fixing apparatus 40.

The fixing apparatus 40 is provided with a fixing belt module 41 having a heat source and a pressure roll 46.

The fixing belt module 41 is disposed on the right side in the drawing of a paper transport path R1. The pressure roll 46 is disposed on the left side in the drawing of the paper transport path R1. Further, the pressure roll 46 is pressed against the fixing belt module 41.

In the fixing belt module 41, a heat source for heating a fixing belt 411 is provided inside the fixing belt 411.

Further, in the present exemplary embodiment, a gas supply apparatus 700 that supplies a gas to the image forming section 10 is provided below the image forming section 10.

The gas supply apparatus 700 is disposed between the image forming section 10 and the paper accommodating section 1B.

The gas supply apparatus 700 is provided with a sending out section 710 that sends out a gas to be supplied to the image forming section 10.

The sending out section 710 is configured by an axial flow fan. The sending out section 710 may have a function of sending out a gas, and a fan other than the axial flow fan may be used.

A motor (not shown) is provided in the sending out section 710. Further, the sending out section 710 is provided with a rotating member 711 that is rotated by the motor. The rotating member 711 rotates about a rotating shaft 712 extending along an up-down direction.

The rotating member 711 is provided with a base portion 711A formed in a columnar shape and rotated by the motor, and a plurality of wing portions 711B protruding from an outer peripheral surface of the base portion 711A.

The wing portions 711B are provided in a state of being inclined with respect to a virtual plane (not shown) orthogonal to the rotating shaft 712.

In the sending out section 710, the rotating member 711 rotates, so that a gas is sent out by the wing portions 711B, and the gas is sent out upward in the drawing.

The gas supply apparatus 700 is further provided with an accommodating member 720 that accommodates the sending out section 710.

In the present exemplary embodiment, a configuration is adopted in which the sending out section 710 is accommodated with respect to the accommodating member 720 from above the accommodating member 720.

Further, the gas supply apparatus 700 is provided with a distribution section 730 that distributes the gas sent out upward by the sending out section 710. The distribution section 730 is disposed between the image forming section 10 and the sending out section 710.

The distribution section 730 is configured by a box-shaped housing, and four discharge ports 731 are provided on a ceiling portion. In addition, an inlet portion 732 through which the gas sent out by the sending out section 710 passes is provided at a bottom portion of the distribution section 730.

The gas sent out from the sending out section 710 first passes through the inlet portion 732 and enters an inside of the distribution section 730. Then, the gas passes through the distribution section 730 and heads to each of the four discharge ports 731. Then, the gas is supplied to the image forming unit 11 positioned above the discharge port 731 through the discharge port 731.

The discharge port 731 is provided for each image forming unit 11, and a gas is supplied from the discharge port 731 to the corresponding image forming unit 11.

More specifically, in the present exemplary embodiment, the discharge port 731 is disposed below the developing apparatus 15, and the gas that has passed through the discharge port 731 is supplied to the developing apparatus 15 positioned above the discharge port 731. Thereby, the developing apparatus 15 is cooled.

In the present exemplary embodiment, the gas from the discharge port 731 is supplied to the developing apparatus 15 in this way. However, the present disclosure is not limited to this, and the gas from the discharge port 731 may be supplied to the photoreceptor drum 12 or the exposure apparatus 300.

An example of the gas supplied by the gas supply apparatus 700 to the image forming unit 11 is air, but other types of gas other than air may be supplied to the image forming unit 11.

In the image forming apparatus 1, the image processing section 35 performs image processing on the image data from the PC 3 or the image reading apparatus 4, and the image data subjected to the image processing is supplied to each image forming unit 11.

Then, for example, in the black (K) color image forming unit 11K, the photoreceptor drum 12 rotating in a direction of an arrow A is charged by the charging apparatus 200. Further, the exposure apparatus 300 that emits light based on the image data transmitted from the image processing section 35 exposes the photoreceptor drum 12.

As a result, an electrostatic latent image related to a black (K) image is formed on the photoreceptor drum 12. Then, the electrostatic latent image formed on the photoreceptor drum 12 is developed by the developing apparatus 15 and a black (K) toner image is formed on the photoreceptor drum 12.

Likewise, yellow (Y), magenta (M), and cyan (C) toner images are formed in the image forming units 11Y, 11M, and 11C, respectively.

The toner images of the respective colors formed by the image forming units 11 are sequentially and electrostatically suctioned by the primary transfer roll 21 onto the intermediate transfer belt 20 moving in a direction of an arrow B and a toner image in which the toners of the respective colors are superimposed is formed on the intermediate transfer belt 20.

The toner image formed on the intermediate transfer belt 20 is transported to the secondary transfer section T configured by the secondary transfer roll 22 as the intermediate transfer belt 20 moves.

Then, the paper P is supplied from the paper accommodating section 1B to the secondary transfer section T in accordance with the timing at which the toner image is transported to the secondary transfer section T.

In the secondary transfer section T, the toner image on the intermediate transfer belt 20 is collectively and electrostatically transferred to the transported paper P by the transfer electric field that is formed by the secondary transfer roll 22.

Subsequently, the paper P on which the toner image has been electrostatically transferred is peeled off from the intermediate transfer belt 20 and transported to the fixing apparatus 40.

In the fixing apparatus 40, the paper P is sandwiched between the fixing belt module 41 and the pressure roll 46. Specifically, the paper P is sandwiched between the fixing belt 411 that circulates and moves in a clockwise direction in the drawing and the pressure roll 46 that rotates in a counterclockwise direction.

Accordingly, the paper P is pressurized and heated, and the toner image on the paper P is fixed to the paper P. Then, the paper P after the fixing is completed is transported to the paper loading section 1E by the discharge rolls 500.

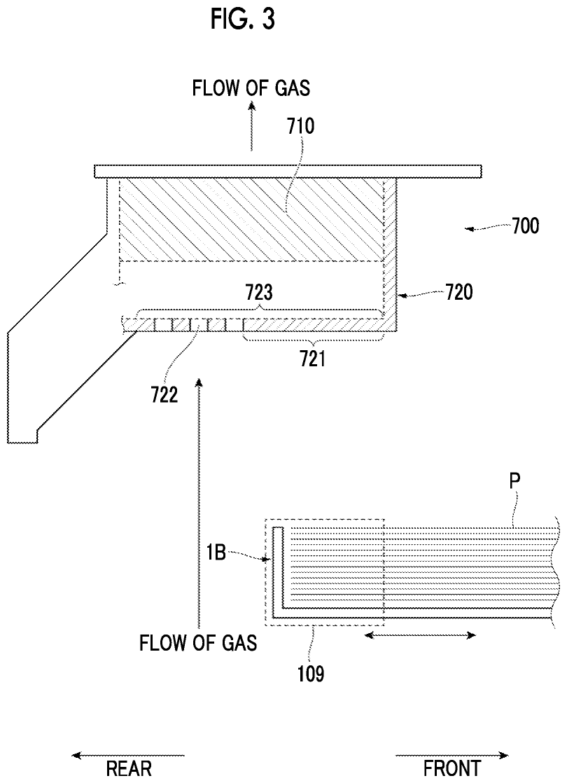

FIG. 3 is a diagram of a case where the sending out section 710, the accommodating member 720, and the like provided in the gas supply apparatus 700 are viewed from a direction indicated by an arrow III in FIG. 1. In each of FIG. 3 and the drawings referred to below, the illustration of the internal configuration of the sending out section 710 is omitted.

In the present exemplary embodiment, as described above and as shown in FIG. 3, the gas supply apparatus 700 is provided with the sending out section 710 for sending out a gas, and is further provided with the accommodating member 720 for accommodating the sending out section 710.

Further, in the present exemplary embodiment, the paper accommodating section 1B is provided below the sending out section 710.

In the present exemplary embodiment, the paper accommodating section 1B can be moved to the right in the drawing.

When the paper accommodating section 1B is replenished with the paper P, the paper accommodating section 1B is moved to the right in the drawing, and then the paper P is replenished to the paper accommodating section 1B.

In a case where the paper accommodating section 1B is replenished with the paper P, the paper accommodating section 1B is moved to the left in the drawing, and the paper accommodating section 1B is returned to the original position.

A receiving section 721 that receives a falling object from the sending out section 710 is provided below the sending out section 710.

In the present exemplary embodiment, toner that exists in the image forming section 10 (see FIG. 1) or powder such as paper dust floating in the image forming section 10 passes through the sending out section 710, becomes a falling object, and moves downward the sending out section 710.

In the sending out section 710, a gap exists between the wing portions 711B (see FIG. 1) adjacent to each other. In this case, the powder existing in the image forming section 10 moves downward through the gap. This powder that moves downward becomes a falling object and heads downward.

In the present exemplary embodiment, the falling object is placed on the receiving section 721 (see FIG. 3), and the movement of the falling object to the paper accommodating section 1B is restricted.

The receiving section 721 is configured by a part of the accommodating member 720.

In addition, the receiving section 721 is disposed between a lower portion 109, which is a portion of the paper accommodating section 1B positioned below the sending out section 710, and the sending out section 710.

The receiving section 721 may be configured by a member different from the accommodating member 720.

In a configuration in which the accommodating member 720 is not provided, a member other than the accommodating member 720 is provided as the receiving section 721, and a member other than the accommodating member 720 receives a falling object.

Further, in the present exemplary embodiment, an opening 722 is provided below the sending out section 710 to allow a gas to pass from below the sending out section 710 toward the sending out section 710. The opening 722 is formed in the accommodating member 720. Further, a plurality of the openings 722 are provided.

In the present exemplary embodiment, the paper accommodating section 1B is provided below the opening 722. Further, in the present exemplary embodiment, the paper accommodating section 1B is provided at a location deviating from below the opening 722.

As a result, a falling object that heads downward from the opening 722 is less likely to reach the paper accommodating section 1B.

In the present exemplary embodiment, although a configuration is adopted in which a portion of the paper accommodating section 1B is disposed below the sending out section 710, a configuration in which the entire portion of the paper accommodating section 1B is positioned below the sending out section 710 is also conceivable.

Even in the configuration in which the entire portion of the paper accommodating section 1B is positioned below the sending out section 710, in a case where the receiving section 721 is provided above the paper accommodating section 1B, a falling object from the sending out section 710 is less likely to reach the paper accommodating section 1B.

In the configuration in which the entire portion of the paper accommodating section 1B is positioned below the sending out section 710, the lower portion 109, which is a portion of the paper accommodating section 1B positioned below the sending out section 710, is the entire portion of the paper accommodating section 1B.

In this case as well, in a case where the receiving section 721 is provided between the sending out section 710 and the lower portion 109, the falling object from the sending out section 710 is less likely to reach the paper accommodating section 1B.

In installing the receiving section 721, for example, it is most preferable that the entire portion of the lower portion 109 is positioned below the receiving section 721.

However, the present disclosure is not limited to this, a configuration may be adopted in which another portion of the lower portion 109 is positioned at a location deviating from below the receiving section 721, such as only a portion of the lower portion 109 is positioned below the receiving section 721 and the other portion of the lower portion 109 is positioned below the opening 722.

Even in a configuration in which only a portion of the lower portion 109 is positioned below the receiving section 721, as compared with a configuration in which the receiving section 721 does not exist above the lower portion 109 at all, it is possible to reduce the falling object that reaches the paper accommodating section 1B.

In the present exemplary embodiment, at least a portion of the receiving section 721 overlaps the paper P accommodated in the paper accommodating section 1B in the up-down direction of the image forming apparatus 1.

Here, “overlapping” refers to a state in which an overlap occurs between the receiving section 721 and the paper P in a case where the two are projected toward a vertical direction and onto a virtual plane orthogonal to the vertical direction.

The above-mentioned “the lower portion 109 is positioned below the receiving section 721” can also be said to be a state in which at least a portion of the receiving section 721 overlaps the paper P accommodated in the paper accommodating section 1B in the up-down direction of the image forming apparatus 1.

In the present exemplary embodiment, the receiving section 721 and the paper P are always in an up-down relationship. In other words, the paper P is always positioned below the receiving section 721.

In the present exemplary embodiment, at least a portion of the receiving section 721 and the paper P accommodated in the paper accommodating section 1B overlap each other in the up-down direction of the image forming apparatus 1.

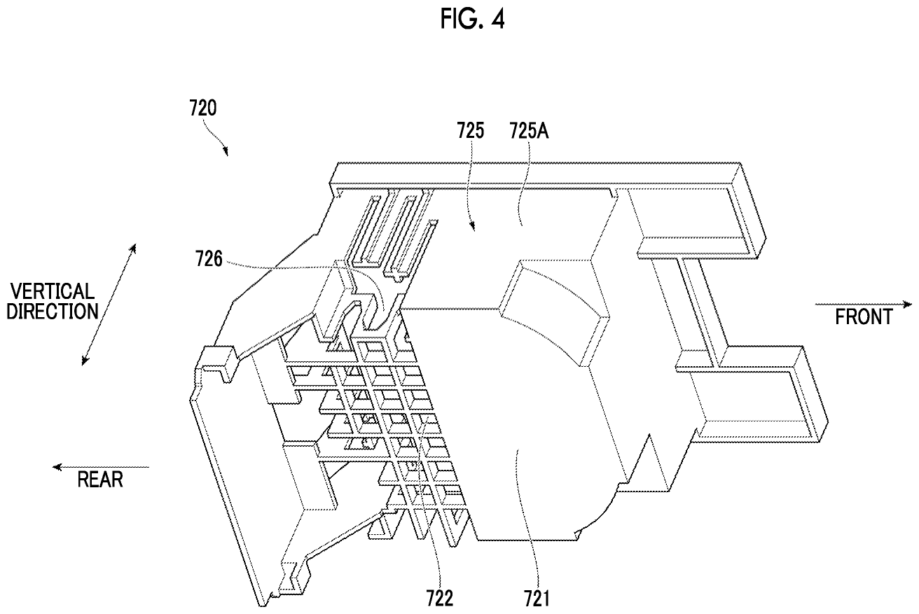

FIG. 4 is a perspective diagram of a case where the accommodating member 720 is viewed from obliquely below.

The accommodating member 720 is provided with the opening 722 as described above. A plurality of the openings 722 are provided. In the present exemplary embodiment, the paper accommodating section 1B (see FIG. 3) is provided at a location deviating from below the plurality of openings 722.

More specifically, the lower portion 109 (see FIG. 3) of the paper accommodating section 1B is positioned at a location deviating from below the plurality of openings 722.

The opening 722 is provided in a bottom portion 723 (see FIG. 3) of the accommodating member 720. Hereinafter, in the present specification, the opening 722 provided in the bottom portion 723 will be referred to as a “bottom opening 722”.

Further, in the present exemplary embodiment, as shown in FIG. 4, an opening 726 is also provided in a side portion 725 of the accommodating member 720. Hereinafter, in the present specification, the opening 726 will be referred to as a “side opening 726”.

The side opening 726 faces a lateral direction which is a direction intersecting the vertical direction.

The bottom opening 722 and the side opening 726 are openings for passing a gas.

In the present exemplary embodiment, a gas heads from an outside of the accommodating member 720 toward an inside of the accommodating member 720 and then heads to the sending out section 710 (see FIG. 3).

The bottom opening 722 and the side opening 726 are openings for passing the gas toward the sending out section 710 from the outside of the accommodating member 720.

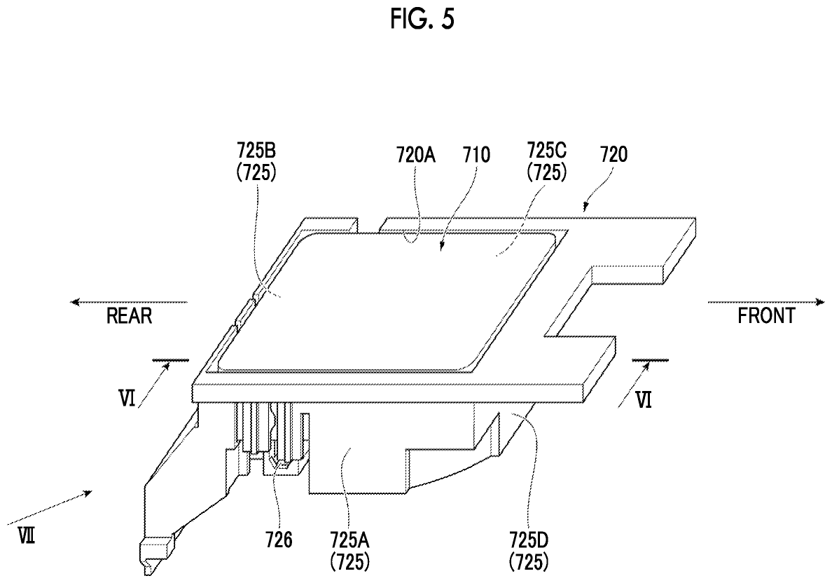

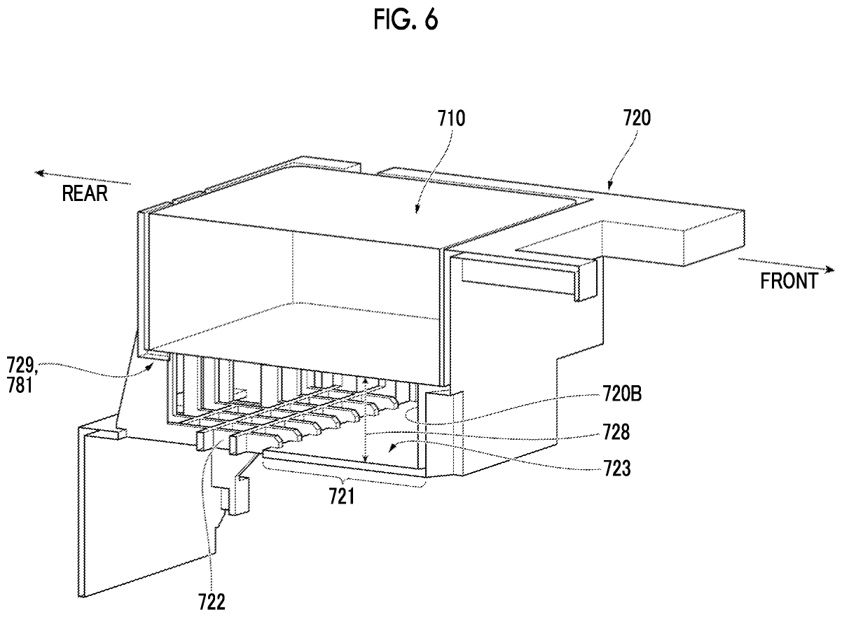

FIG. 5 is a perspective diagram of a case where the accommodating member 720 and the sending out section 710 are viewed from above. FIG. 6 is a cross-sectional diagram of the accommodating member 720 and the sending out section 710 in VI-VI line of FIG. 5.

As shown in FIG. 5, the accommodating member 720 of the present exemplary embodiment is formed in a box shape and in a rectangular shape. The accommodating member 720 is provided with four side portions, a first side portion 725A to a fourth side portion 725D, as the side portions 725.

In the present exemplary embodiment, in a case where the side portion positioned on the front side in the drawing is the first side portion 725A, the first side portion 725A to the fourth side portion 725D are provided in the order of the first side portion 725A to the fourth side portion 725D in the clockwise direction from the first side portion 725A.

The side opening 726 shown in FIG. 4 is a side opening 726 formed in the first side portion 725A.

As shown in FIG. 5, a rectangular opening 720A is provided in an upper portion of the accommodating member 720. Further, in the present exemplary embodiment, as shown in FIG. 6, a recess portion 720B that faces downward from the rectangular opening 720A is provided.

In the present exemplary embodiment, as shown in FIG. 5, the sending out section 710 having a rectangular shape is accommodated in the recess portion 720B. In I the present exemplary embodiment, the sending out section 710 is accommodated from above the accommodating member 720.

In the present exemplary embodiment, as described above and as shown in FIG. 6, the accommodating member 720 is provided with the bottom portion 723.

In the present exemplary embodiment, the receiving section 721 described above is configured by the bottom portion 723 of the accommodating member 720. Further, the bottom opening 722 described above is provided in the bottom portion 723.

The bottom opening 722 is an opening for allowing air to pass from below the accommodating member 720 toward the sending out section 710.

In the present exemplary embodiment, as shown in FIG. 3, the paper accommodating section 1B is provided at a location deviating from below the bottom opening 722 provided in the bottom portion 723 of the accommodating member 720. In the present exemplary embodiment, a configuration is adopted in which the bottom opening 722 formed in the accommodating member 720 is not positioned above the paper accommodating section 1B.

As shown in FIG. 6, a gap 728 is provided between the bottom portion 723 and the sending out section 710.

In the present exemplary embodiment, a step 729 is provided on an inner surface of the accommodating member 720, and the step 729 restricts the downward movement of the sending out section 710. As a result, the gap 728 is generated between the bottom portion 723 and the sending out section 710.

In other words, the accommodating member 720 is provided with a restricting section 781 that restricts the downward movement of the sending out section 710 inserted in the recess portion 720B.

The restricting section 781 restricts the downward movement of the sending out section 710, and the gap 728 is generated between the bottom portion 723 of the accommodating member 720 and the sending out section 710.

In a case where the gap 728 is provided between the bottom portion 723 of the accommodating member 720 and the sending out section 710, as compared with a configuration in which the gap 728 is not provided, wind noise generated when the gas below the bottom opening 722 passes through the bottom opening 722 is reduced.

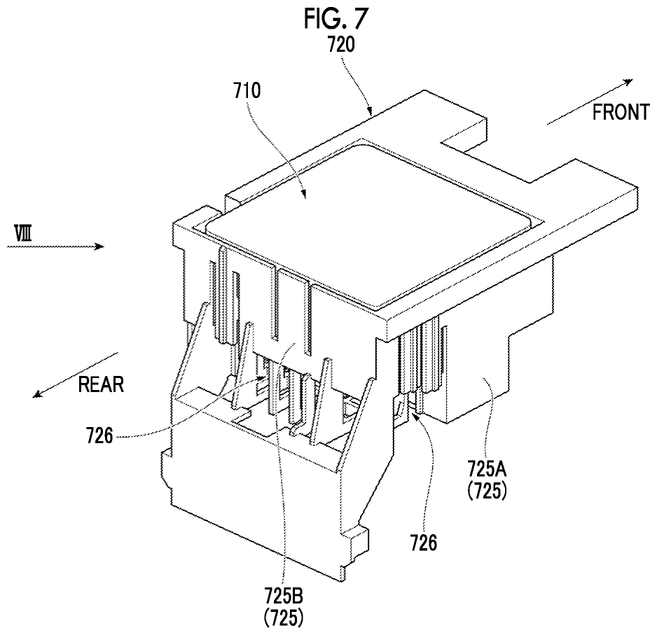

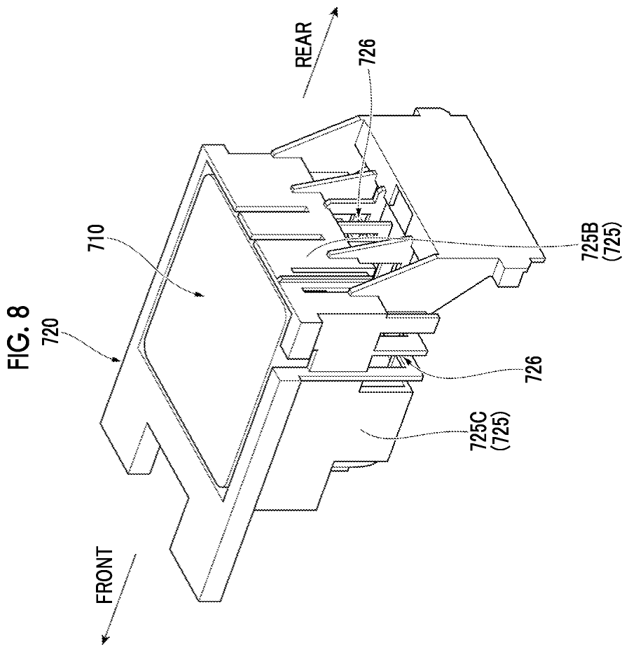

FIG. 7 is a diagram of a case where the accommodating member 720 and the sending out section 710 are viewed from a direction indicated by an arrow VII in FIG. 5. FIG. 8 is a diagram of a case where the accommodating member 720 and the sending out section 710 are viewed from a direction indicated by an arrow VIII in FIG. 7.

In the present exemplary embodiment, as shown in FIGS. 7 and 8, the side openings 726 are provided at a plurality of locations of the side portions 725 of the accommodating member 720.

In the present exemplary embodiment, the side portions 725 are configured by the first side portion 725A to the fourth side portion 725D as described above.

In the present exemplary embodiment, as shown in FIG. 7, the side opening 726 is provided in each of the first side portion 725A and the second side portion 725B, and as shown in FIG. 8, the side opening 726 is provided in the third side portion 725C.

In the present exemplary embodiment, side openings 726 are provided at a plurality of locations of the side portions 725 of the accommodating member 720. Further, in the present exemplary embodiment, each of the first side portion 725A to the third side portion 725C is provided with a plurality of side openings 726.

As shown in FIG. 5, the first side portion 725A to the fourth side portion 725D are disposed such that positions thereof in the rotation direction of the rotating member 711 (see FIG. 1) provided in the sending out section 710 are different from each other.

In the present exemplary embodiment, the side openings 726 provided in the first side portion 725A to the third side portion 725C are also disposed such that the positions thereof in the rotation direction of the rotating members 711 are different from each other.

In the present exemplary embodiment, as shown in FIG. 1, the sending out section 710 is provided with the rotating member 711 that rotates about the rotating shaft 712 extending along the up-down direction.

The side openings 726 provided in the first side portion 725A to the third side portion 725C are disposed such that the positions thereof in the rotation direction of the rotating member 711 are different from each other.

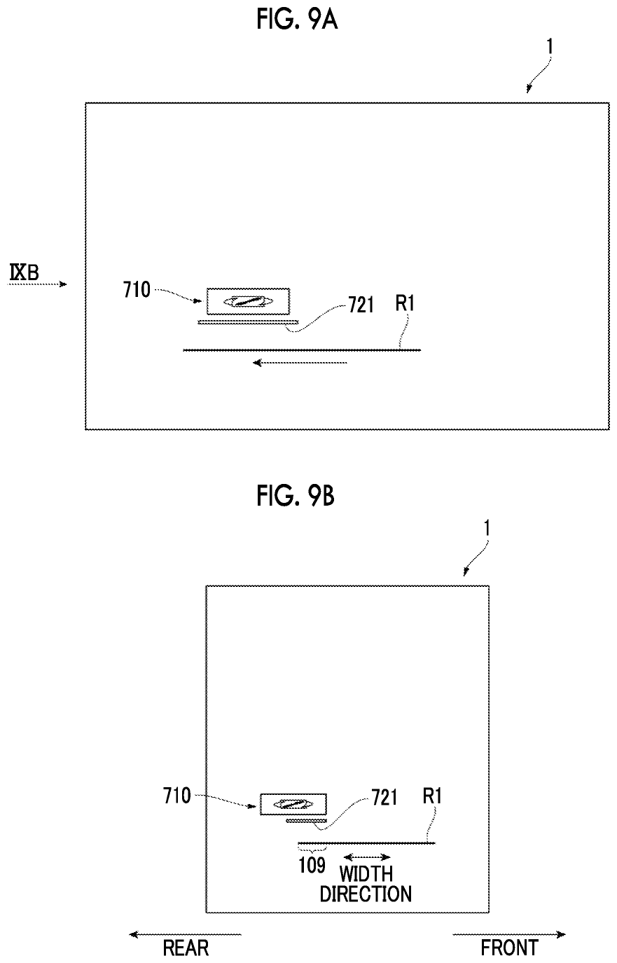

FIGS. 9A and 9B are diagrams showing other configuration examples of the image forming apparatus 1.

FIG. 9A shows a state in a case where the image forming apparatus 1 is viewed from the front. FIG. 9B shows a state in a case where the image forming apparatus 1 is viewed from a direction indicated by an arrow IXB in FIG. 9A.

In the above description, a configuration example in which the paper accommodating section 1B is positioned below the sending out section 710 has been described as an example.

The present disclosure is not limited to this, as shown in FIGS. 9A and 9B, depending on the apparatus configuration of the image forming apparatus 1, a case is also conceivable in which a portion or entire portion of the paper transport path R1, through which the paper P to be transported passes, is provided below the sending out section 710.

In addition, in FIG. 9A, the paper P moves to the left in the drawing along the paper transport path R1. Further, in FIG. 9B, the paper transport path R1 extends in a direction orthogonal to the paper surface of FIG. 9B, and in FIG. 9B, the paper P moves in a direction orthogonal to the paper surface of FIG. 9B.

In the configuration example as well, as shown in FIG. 9B, the receiving section 721 for receiving a falling object from the sending out section 710 is provided between the lower portion 109, which is a portion of the paper transport path R1 positioned below the sending out section 710, and the sending out section 710.

Accordingly, in the configuration example, the falling object from the sending out section 710 is less likely to reach the paper transport path R1, and the falling object is less likely to adhere to the paper P passing through the paper transport path R1.

Similar to the above, the receiving section 721 may be configured by the accommodating member 720 (not shown in FIG. 9), or may be configured by a member different from the accommodating member 720.

In the configuration example shown in FIG. 9, as shown in FIG. 9B, a configuration is adopted in which a portion of the paper transport path R1 in a width direction is positioned below the sending out section 710.

Incidentally, as an aspect of disposition of the paper transport path R1, a configuration is also conceivable in which the entire portion of the paper transport path R1 in the width direction is positioned below the sending out section 710.

Even in the configuration in which the entire portion of the paper transport path R1 in the width direction is positioned below the sending out section 710, in a case where the receiving section 721 is provided between the lower portion 109 and the sending out section 710, the falling object from the sending out section 710 is less likely to reach the paper transport path R1.

In the same manner as described above, a configuration may also be adopted in which another portion of the lower portion 109 is positioned at a location deviating from below the receiving section 721, such as only a portion of the lower portion 109 is positioned below the receiving section 721, and the other portion of the lower portion 109 is not positioned below the receiving section 721.

Even in the configuration in which only a portion of the lower portion 109 is positioned below the receiving section 721, as compared with a configuration in which the receiving section 721 does not exist above the lower portion 109 at all, it is possible to reduce the falling object that reaches the paper transport path R1.

### Supplementary Note

(((1)))

An image forming apparatus comprising:

an image forming section that forms an image to be formed on a recording medium;

a sending out section that sends out a gas to be supplied to the image forming section;

an accommodating section that is at least partially disposed below the sending out section and that accommodates the recording medium; and

a receiving section that is disposed between a lower portion, which is a portion of the accommodating section positioned below the sending out section, and the sending out section, and receives a falling object from the sending out section.

(((2)))

The image forming apparatus according to (((1))),

wherein an opening is provided below the sending out section to allow a gas to pass from below the sending out section toward the sending out section,

the accommodating section is provided below the opening, and

the accommodating section is provided at a location deviating from below the opening.

(((3)))

The image forming apparatus according to (((2))),

wherein a plurality of openings are provided, and some of the plurality of openings face in a lateral direction which is a direction intersecting a vertical direction.

(((4)))

The image forming apparatus according to (((1))), further comprising:

an accommodating member that accommodates the sending out section, in which the sending out section is accommodated from above the accommodating member,

wherein the receiving section is configured by a bottom portion of the accommodating member.

(((5))

The image forming apparatus according to (((4))),

wherein the bottom portion of the accommodating member is provided with an opening for allowing air to pass from below the accommodating member toward the sending out section, and

the accommodating section is provided at a location deviating from below the opening provided in the bottom portion of the accommodating member.

(((6)))

The image forming apparatus according to (((5))),

wherein a gap is provided between the bottom portion provided with the opening and the sending out section.

(((7)))

The image forming apparatus according to (((4))),

wherein an opening is provided in a side portion of the accommodating member to allow a gas to pass from an outside of the accommodating member toward an inside of the accommodating member and then toward the sending out section.

(((8)))

The image forming apparatus according to (((7))),

wherein the sending out section is provided with a rotating member that rotates about a rotating shaft extending along an up-down direction, and

a plurality of openings provided on the side portion of the accommodating member are provided, and the plurality of openings are disposed such that positions thereof in a rotation direction of the rotating member are different from each other.

(((9)))

An image forming apparatus comprising:

an image forming section that forms an image to be formed on a recording medium;

a sending out section that sends out a gas to be supplied to the image forming section;

a transport path that is at least partially disposed below the sending out section and through which the recording medium to be transported passes; and

a receiving section that is disposed between a lower portion, which is a portion of the transport path positioned below the sending out section, and the sending out section, and receives a falling object from the sending out section.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
an image forming section that forms an image to be formed on a recording medium;
a sending out section that sends out a gas to be supplied to the image forming section;
an accommodating section that is at least partially disposed below the sending out section and that accommodates the recording medium; and
a receiving section that is disposed between a lower portion, which is a portion of the accommodating section positioned below the sending out section, and the sending out section, and receives a falling object from the sending out section.

2. The image forming apparatus according to claim 1,
wherein an opening is provided below the sending out section to allow a gas to pass from below the sending out section toward the sending out section,
the accommodating section is provided below the opening, and
the accommodating section is provided at a location deviating from below the opening.

3. The image forming apparatus according to claim 2,
wherein a plurality of openings are provided, and some of the plurality of openings face in a lateral direction which is a direction intersecting a vertical direction.

4. The image forming apparatus according to claim 1, further comprising:
an accommodating member that accommodates the sending out section, in which the sending out section is accommodated from above the accommodating member,
wherein the receiving section is configured by a bottom portion of the accommodating member.

5. The image forming apparatus according to claim 4,
wherein the bottom portion of the accommodating member is provided with an opening for allowing air to pass from below the accommodating member toward the sending out section, and
the accommodating section is provided at a location deviating from below the opening provided in the bottom portion of the accommodating member.

6. The image forming apparatus according to claim 5,
wherein a gap is provided between the bottom portion provided with the opening and the sending out section.

7. The image forming apparatus according to claim 4,
wherein an opening is provided in a side portion of the accommodating member to allow a gas to pass from an outside of the accommodating member toward an inside of the accommodating member and then toward the sending out section.

8. The image forming apparatus according to claim 7,
wherein the sending out section is provided with a rotating member that rotates about a rotating shaft extending along an up-down direction, and
a plurality of openings provided on the side portion of the accommodating member are provided, and the plurality of openings are disposed such that positions thereof in a rotation direction of the rotating member are different from each other.

9. An image forming apparatus comprising:
an image forming section that forms an image to be formed on a recording medium;
a sending out section that sends out a gas to be supplied to the image forming section;
a transport path that is at least partially disposed below the sending out section and through which the recording medium to be transported passes; and
a receiving section that is disposed between a lower portion, which is a portion of the transport path positioned below the sending out section, and the sending out section, and receives a falling object from the sending out section.
